(19) United States
(12) Patent Application Publication
(10) Pub. No.: US 2025/0326662 A1
(43) Pub. Date: Oct. 23, 2025

(54) COOLING PROCESS TO TREAT DESALTER WATER EFFLUENT FOR WASH WATER REUSE

(71) Applicant: Saudi Arabian Oil Company, Dhahran (SA)

(72) Inventors: Khaled Nafee, Dammam (SA); Emhemmed AEA Youssef, Dhahran (SA); Abdulaziz Y. AlAmmar, Dammam (SA)

(21) Appl. No.: 18/643,461

(22) Filed: Apr. 23, 2024

(51) Int. Cl. C02F 1/26; C02F 1/44; C02F 101/32; C02F 103/08

(52) U.S. Cl. CPC C02F 1/265; C02F 1/441; C02F 1/442; C02F 2101/322; C02F 2103/08

(57) ABSTRACT

This disclosure relates to the method and system of cooling a pre-treated produced water stream in a gas oil separation plant (GOSP), using a heat integration concept. The pre-treated produced water stream is cooled by multiple heat exchangers arranged in series or in parallel. The cooled pre-treated produced water stream is desalinated to produce a permeate stream and a brine reject stream. The permeate and brine reject streams are used as the cooling media for the heat exchangers. This operates in a cyclic way, such that the permeate stream from the desalination unit heats up while cooling the pre-treated produced water. The heated permeate stream is used as a wash water stream for a desalter unit in the GOSP. This method reduces the reliance on an external fresh water source for the wash water stream and provides an energy efficient way of cooling the pre-treated produced water stream.

### TECHNICAL FIELD

This disclosure relates to methods implemented in a gas oil separation plant that processes hydrocarbons.

### BACKGROUND

Hydrocarbons produced from a subterranean formation undergo processing by a high pressure production trap (HPPT) to form crude oil and produced water. The crude oil is further processed by a dehydrator and desalter unit in a gas oil separation plant (GOSP). The desalter unit reduces the salt content of the crude oil by using wash water to lower salinity of the crude oil. Doing so prevents corrosion of the pipelines downstream of the desalter unit. The effluent water from the desalter unit can be sent to an injection well or discarded. The wash water for a desalter unit can be obtained from fresh water sources such as groundwater. However, in GOSPs that have limited access to fresh water sources, obtaining groundwater can be challenging. Hence, the recycle and reuse of desalter effluent water or produced water can be an alternative to freshwater sources.

### SUMMARY

This disclosure describes technologies relating to the cooling process of the treated desalter effluent water, which is reused as a wash water for the desalter unit.

The details of one or more implementations of the subject matter of this specification are set forth in the detailed description, the accompanying drawings, and the claims. Other features, aspects, and advantages of the subject matter will become apparent from the detailed description, the claims, and the accompanying drawings.

### BRIEF DESCRIPTION OF DRAWINGS

FIG. 1 is a block flow representation of the desalter effluent treatment process.

FIG. 2 is a block flow representation of an example of an integrated desalter effluent treatment process with multi-stage cooling using a heat exchanger system.

FIG. 3 is a process simulation representing the multi-stage cooling of treated desalter effluent using a heat exchanger system connected in series.

FIG. 4 is a block flow representation of an example of an integrated desalter effluent treatment process with multi-stage cooling using a combination of heat exchangers and a cooling system.

FIG. 5 is a process simulation representing the multi-stage cooling of treated desalter effluent using a combination of heat exchangers and a cooling system.

FIG. 6 is a flowchart of an example of a process of desalter effluent treatment.

### DETAILED DESCRIPTION

Oil and gas production results in the recovery of crude oil that includes a large volume of produced water. In a gas and oil separation plant (GOSP), a desalter unit is used to reduce the salt content of crude oil to prepare the oil for shipment or refineries. The desalter requires fresh water to desalt produced oil streams. Fresh water availability is becoming scarcer worldwide. This increases the cost of production of crude oil as it creates greater operating costs. The desalter water effluent is generally re-injected into a reservoir or disposed of without reuse, due to high operational and maintenance costs associated with conventional water treatment methodologies.

The desalter effluent water is rich in hydrocarbons, chemicals, salts, suspended solids, and other inorganic and organic components. It varies considerably based on the geographic formation, type of hydrocarbon produced, and variations in chemicals used during oil productions. This variation makes the treatment of desalter effluent water more challenging and thus requires specific treatment technologies.

Desalination is one of the processes for the treatment of desalter effluent water to be reused as wash water. Desalination reduces the total dissolved solids (TDS) to a pre-determined level that is required for use as a wash water. Certain systems use mechanical vapor compressor (MVC) technology for high TDS desalination. MVCs can treat high TDS water, but the technology has high initial capital expenditure (CAPEX) and operating costs (OPEX). Also, the technology requires cooling and auxiliary boilers, where excess steam is not available for the start-up. Reducing both TDS and organics in such systems can include processes that utilizes ultrafiltration (UF), air stripper, cooling system, and reverse osmosis (RO) or nanofiltration (NF). However, polymer-based NF and RO used in general water treatment and desalination are not favorable to treat produced water or waste water from oil and gas processing facilities. This is because the polymer based membranes of NF and RO have a temperature tolerance limit of 35-40° C., which is lesser than the typical temperature of produced water in a GOSP at 50-70° C. As a result, it is necessary to install cooling towers upstream of the NF or RO.

The cooling tower principle relies on water evaporation to dissipate heat to the environment, resulting in cooling the remaining water. Therefore, the cooling tower is expected to lose a significate amount of water. The water loss occurs from both evaporation and drift. Another limitation of the cooling tower is the increase of dissolved ions concentration as a result of the evaporation of water. This leads to the accumulation of ions such as chloride, sodium, magnesium, etc., which impact the desalination membrane. This disclosure addresses the challenges of using a cooling tower by applying a heat integration concept using heat exchangers.

An embodiment described here provides a method for treating and cooling the effluent water from a desalter unit prior to desalination, in a GOSP. The effluent water is separated in a water oil separator (WOSEP) to produce a recovered oil stream and a produced water stream. The produced water stream is treated to remove suspended oil, dissolved H₂S, dissolved organics, hardness, and small colloidal particles prior to the desalination process. The membrane based desalination process has a temperature limitation of 35° C. Therefore, the treated produced water is cooled prior to desalination.

The heat integration technique utilizes multiple heat exchangers, which use the permeate stream and the reject brine stream from the desalination unit as the cooling media. This heat integration not only cools the incoming produced water stream, but also heats the permeate stream. The heated permeate stream is reused as a wash water stream for the desalter unit. This process operates continuously in a cyclic way to reduce the dependence on fresh water sources for desalting crude oil. According to this innovative process, a heat recovery rate of around 60% is expected through the introduction of two heat exchangers. The remaining 40% of the available energy is recovered using groundwater as a cooling media for the 3^{rd} heat exchanger.

This disclosure describes using a heat integration concept to cool the treated produced water prior to flowing through the desalination unit. It utilizes multiple heat exchangers arranged in series or parallel to step down the temperature of the produced water stream from the WOSEP. The cooled produced water stream flows through a RO or NF membrane in the desalination unit. The desalination process produces a permeate stream and a brine reject stream. The permeate stream has a reduced salinity (TDS) compared to the initial salinity of the produced water. The permeate stream and the brine reject stream are used as cooling media for the first and second heat exchangers, respectively. An aspect described here utilizes a third heat exchanger that is connected in series or parallel to the first and second heat exchanger. The third heat exchanger uses groundwater as a cooling medium.

An aspect described here uses a heat integration concept to cool the treated produced water prior to flowing through the desalination unit. The heat integration uses two heat exchangers connected in series or parallel with a cooling system. The first and second heat exchanger use a permeate stream and a brine reject stream from the desalination unit as the cooling media. The temperature of the produced water is reduced from its initial temperature, while also increasing the temperature of the permeate stream and brine reject stream simultaneously. A portion of the permeate stream is used as a wash water for the desalter unit. In some implementations, the cooled produced water stream is used as a cooling medium for one of the heat exchangers. The cooling system includes either a third heat exchanger or a cooling tower. When a third heat exchanger is used, groundwater is used as a cooling medium for the third heat exchanger. In the absence of a groundwater supply source, a cooling tower or an evaporative chiller can be integrated with the first and second heat exchangers connected in series or parallel.

Although GOSPs using desalters have existed for decades, the generally accepted belief has been that recycling desalter effluent water is not economically feasible due to the technical challenges of temperature, ion removal, and polymeric material degradation. The current disclosure addresses the challenges of previous treatment methodologies.

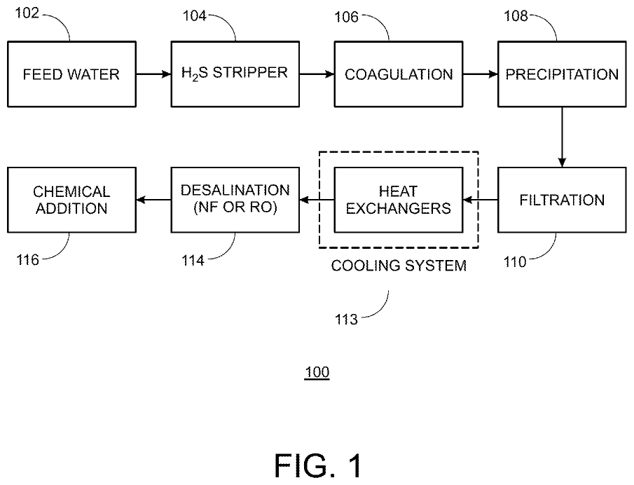

FIG. 1 is a block flow diagram of a desalter effluent treatment process 100. The produced effluent water from the desalter unit undergoes a separation in a WOSEP to produce a recovered oil stream and a produced water stream. The produced water stream, also called as the feed water 102 is passed through a hydroclone to remove suspended oil droplets and a nutshell filter to remove emulsified oil, before being processed by a H₂S stripper 104. The feed water 102 includes H₂S, ammonia, and other volatile organic compounds (VOCs). The H₂S stripper 104 is a distillation column where the feed water is heated by steam. The steam is obtained from a reboiler. As the feed water is heated, the H₂S gas flows upwards in the column and is stripped overhead. The obtained H₂S is of high purity and sent to the sulfur recovery unit (SRU). In some implementations, a second stripper in installed to recover ammonia and other VOCs using steam. In some implementations, the pH is adjusted to below 5 for stripping H₂S. Above pH 5, sulfur exists as ions. Similarly, the pH is adjusted to above 10 for efficient ammonia removal.

The feed water 102 after being stripped of H₂S and VOCs is processed by a coagulation unit 106. The coagulation unit 106 uses a specific chemical called ‘coagulant’, which helps in bringing insoluble fine particles together by manipulating the charge on the particles. The insoluble particles form large aggregates called as ‘floc’. The coagulation process also aides in the adsorption of dissolved organic matter on the particle aggregates. The coagulants used in the process include iron or aluminum salts. After the feed water is coagulated, the water can be moved to a settling tank, in which the heavy particles settle at the bottom due to gravity. Some implementations include a filtration system to remove the particle aggregates.

The coagulated water from the coagulation unit 106 is processed by a precipitation tank 108. Water hardness, primarily caused by the dissolution of calcium and magnesium carbonate and bicarbonates is removed in the precipitation tank 108. To a lesser extent, water hardness is also caused by sulfates, chlorides, and silicates of metals. The removal of these dissolved compounds is called water softening and proceeds by chemical precipitation. In some implementations, lime, alum, ferrous sulfates are added for water softening and metal removal. The solubility of the metal compounds and counter ions are pH dependent. Once a precipitate is formed, it is removed by settling. The settling process can be accelerated by adding a polymer coagulant.

The water from the precipitation tank 108 is processed by the filtration system 110. The filtration system 110 includes ultra filtration (UF) or microfiltration (MF) to remove colloidal particles that tend to cause fouling on the RO or NF membrane. The UF and MF cannot remove ions and therefore a desalination step is required to remove the dissolved ions. In some implementations, the filtration membrane is made of ceramic materials that have a high temperature tolerance. The ceramic material can remove dissolved gases such as H₂S, dissolved organics, suspended and emulsified oils as well. The temperature of the feed water 102 at the end of the filtration step is approximately 70-90° C.

The treated feed water from the filtration has to be cooled down to 35-40° C. before flowing through a desalination unit 114. The treated feed water undergoes a cooling process in a cooling system 113. Some implementations use a cooling tower, a evaporative cooler, or a chiller. The cooling tower principle relies on water evaporation to dissipate heat to the environment, resulting in cooling the remaining water. Therefore, the cooling tower is expected to lose a significate amount of water. The water loss is from evaporation and drift (Equation 1). A typical evaporation loss from a cooling tower is primarily dependent on the amount of heat being rejected or dissipated as shown in Equation 2.

$$Water Loss = Evaporation + Drift \qquad Equation 1$$

$$E = \frac{C ( Ti - To ) {C}_{p}}{λ} \qquad Equation 2$$

E: Evaporation loss in m³/hr
C: Water flow in m³/hr
λ: Latent heat of vaporization kJ/kg
Ti−To: Water temperature difference across the tower in ° C.
Cₚ: Specific heat in kJ/kg ° C.

Drift refers to the small amount of water droplets that are carried out of the cooling water along with the exhaust air. As water evaporates to cool the remaining water in the tower, small droplets can entrain in the air (e.g., these droplets may contain chemicals and other dissolved solids). They are expelled from the tower and into the environment.

The cooling tower also leads to an increase in dissolved ions concentration such as chloride, sodium, magnesium, etc., because of evaporation. As mentioned above, this increase in dissolved ions can impact the desalination step. A heat integration concept that uses multiple heat exchangers to step down the temperature of the treated and filtered feed water is applied. This heat integration is beneficial because it cools down the incoming treated and filtered feed water and heats up the cooling medium used in the heat exchanger, simultaneously. This cooling system introduces the permeate stream and the brine reject stream from the desalination unit 114 as a cooling media for the heat exchangers.

The cooled feed water from the cooling system 113 is processed by a desalination unit 114. The desalination unit 114 includes a RO or NF membrane. The membrane can include a polymeric material. In some implementations a ultra-high pressure RO (UHPRO) membrane is used. These membranes are susceptible to fouling and therefore the pre-treatment steps are necessary to prevent frequent replacement of the membrane. The RO and NF have a temperature limitation of 35-40° C. The desalination process removes dissolved ions and reduces the TDS from 16,000 ppm to ˜1000 ppm. Desalination produces a permeate water stream with a significantly reduced TDS (salinity reduced from 16,000 ppm to ˜1000 ppm TDS) and a brine reject stream with a high TDS. The permeate and brine reject stream have a temperature of ˜35° C. and are used as the cooling media for the heat exchangers in the cooling system 113. The desalinated water undergoes chemical addition 116. The chemicals added are oxygen scavengers and biocides that prevent bacterial growth in the water. A portion of the treated water is reused as wash water by a desalter unit.

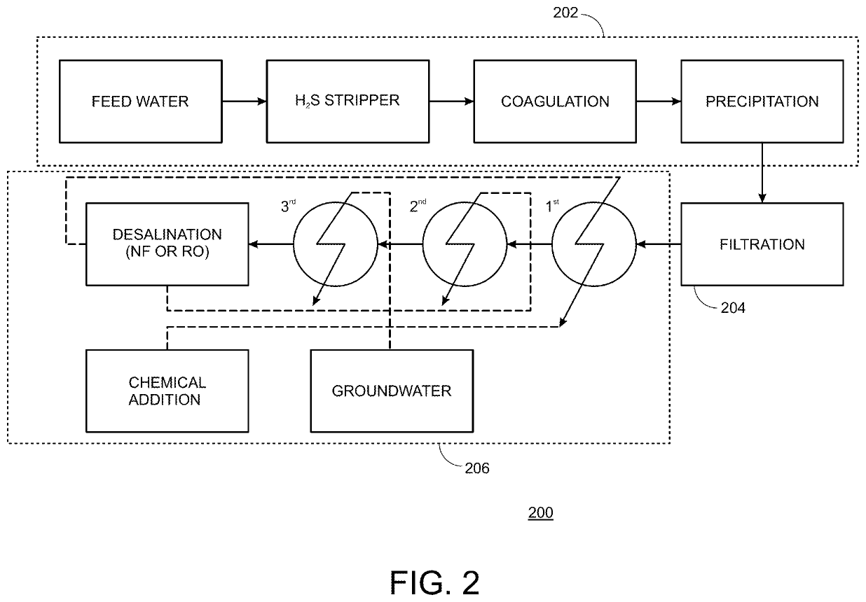

FIG. 2 is a block flow representation of an integrated desalter effluent treatment process 200 with multi-stage cooling using three heat exchangers.

The desalter effluent water from the WOSEP is separated into a recovered oil stream and a produced water stream. The produced water stream undergoes a series of pre-treatment processes 202 to remove suspended oil, emulsified oil, sulfur containing gases such as H₂S, volatile organic compounds, hardness, fine colloidal particles and dissolved organic content as described in FIG. 1. The treated produced water stream is filtered in the filtration unit 204. The heat integration concept is applied to the treated and filtered produced water for reducing its temperature prior to flowing it through the desalination unit. The cooling system 206 includes the introduction of the permeate stream from the membrane desalination unit to lower the temperature of the treated produced water feed from the filtration process using heat exchangers in series or in parallel.

In implementations herein, the treated produced water exiting the filtration unit 204 is in the range of 50-70° C. In examples here, the treated produced water is cooled down from 70° C. to 56° C. using the first heat exchanger with the permeate stream as the cooling medium. The produced water cooled by the first heat exchanger is the first stage cooled produced water. The temperature of the permeate stream can increase to up to 55° C. during the cooling process. A portion of this heated permeate stream is reused as a wash water stream for the desalter unit. The desalter unit uses a wash water stream at an elevated temperature to desalt crude oil.

A second heat exchanger is used to cool down the first stage cooled produced water. In examples here, the first stage cooled produced water's temperature is lowered from 56° C. to 50° C. The brine reject stream from the desalination unit is used as the cooling medium for the second heat exchanger. This results in a second stage cooled produced water.

In some implementations, groundwater may be available in the GOSPs at low temperatures (5° C. to 20° C.). In such implementations, a third heat exchanger is utilized to lower the temperature of the second stage cooled produced water from 50° C. to below 35° C. by using the groundwater as a cooling medium, resulting in a third stage cooled produced water. In some implementations, the third stage cooled produced water is utilized as a cooling medium for the first or second heat exchanger.

In examples above, the stage wise cooling of the treated produced water is done using multiple heat exchangers connected in series. In certain implementations, the stage wise cooling can be done using multiple heat exchangers connected in parallel or other configurations to maximize the heat coefficient. In certain implementations, the treated produced water stream can be split into multiple streams and processed parallelly by the heat exchangers to exchange heat with the permeate stream, brine reject stream, and the groundwater stream. This configuration can maximize heat coefficient.

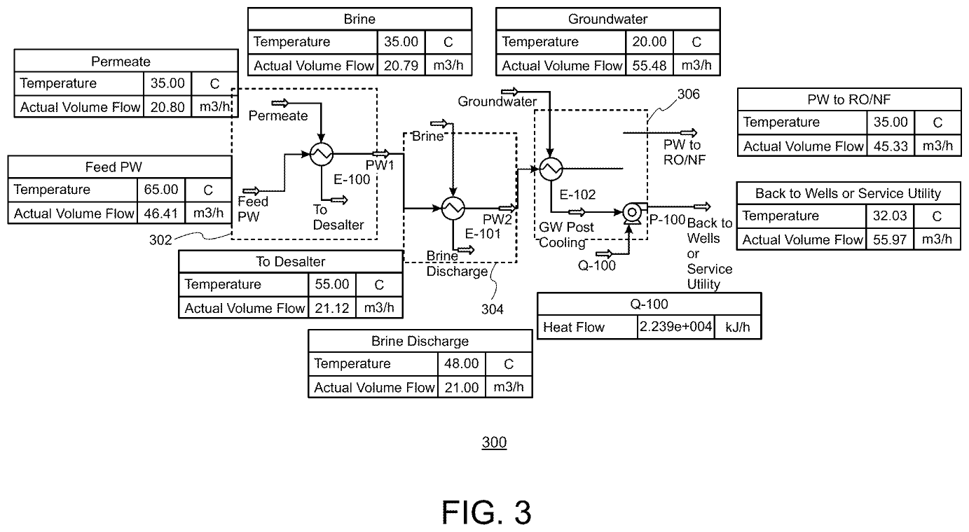

FIG. 3 is a process simulation representing the multi-stage cooling of treated desalter effluent 300 using a heat exchanger system connected in series. The process simulation of FIG. 3 describes an example of multi-stage cooling with reference to FIG. 2. The initial temperature of the treated produced water (Feed PW) is 65° C. It is processed by the first heat exchanger in block 302. A permeate stream from the desalination unit, at a temperature of 35° C. is used as the cooling medium for the first heat exchanger. The first stage cooled produced water (PW1) exits the first heat exchanger and flows into block 304 for the second stage of cooling. The discharge permeate is heated to 55° C. and recycled to the desalter unit as a wash water stream. A second heat exchanger in block 304 uses the reject brine stream from the desalination unit, which has a temperature of 35° C., as the cooling medium. The exiting second stage cooled produced water (PW2) enters block 306. Block 306 includes a third heat exchanger that uses ground water at a temperature of 20° C. as the cooling medium. The third stage cooled produced water (PW) is sent to the desalination unit for further continuation of the process. The post cooling groundwater is sent back to the wells as injection water, for service utilities, or for reservoir pressure maintenance. This process operates as a continuous cycle, to supply a wash water stream to the desalter unit. The effluent from the desalter is treated and once again filtered, cooled, and desalinated. In some implementations, the heat exchanger's efficiency is enhanced by employing fins, extended surfaces, or other heat transfer enhancement techniques.

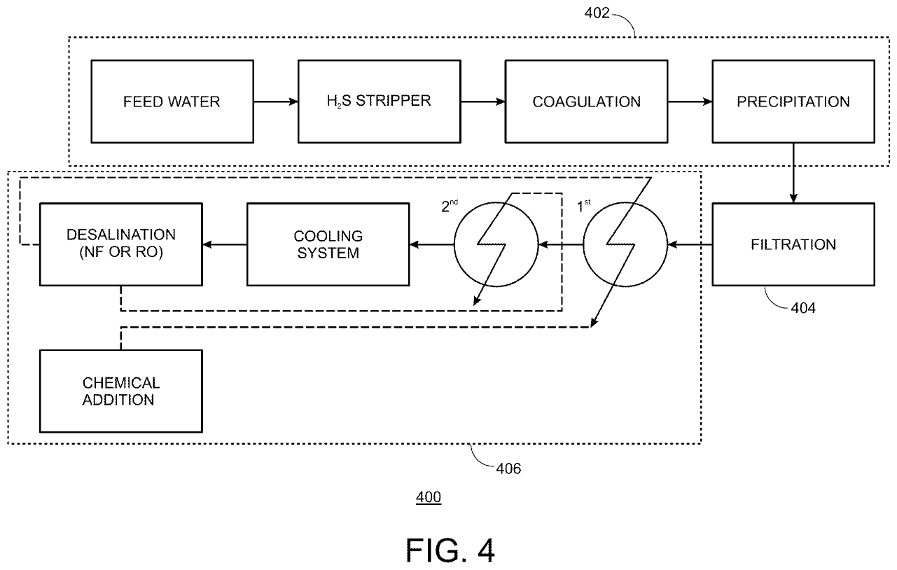

FIG. 4 is a block flow representation of an integrated desalter effluent treatment process 400 with multi-stage cooling using a combination of heat exchangers and a cooling system. The produced water from the WOSEP is pretreated in block 402 to remove suspended and emulsified oil droplets, dissolved H₂S gas and VOCs, hardness causing ions, dissolved organic content, and small colloidal particles. The treated produced water is filtered in a filtration unit 404. The treated and filtered produced water is cooled down by a heat integrated system 406.

Some portions of the block flow representation are substantially identical to those described in FIG. 2. In some implementations, the heat integration unit includes the first heat exchanger, the second heat exchanger, and third a cooling system. The first heat exchanger uses the permeate stream from the desalination unit as the cooling medium. This cooling step results in the first stage cooled produced water. The permeate stream heats up during the cooling process. A portion of this heated permeate stream is reused as a wash water stream for the desalter unit. A second heat exchanger is used to cool down the first stage cooled produced water. The brine reject stream from the desalination unit is used as the cooling medium for the second heat exchanger. This results in a second stage cooled produced water. In case there is a non-availability of groundwater at 5° C. to 20° C. temperate range, a cooling system is installed, to cool the second stage cooled produced water from 50° C. to below 35° C. This configuration minimizes the energy required by the cooling system, as most of the energy to bring down the temperature of the treated produced water is accomplished by the first and second heat exchangers. The cooling system includes a cooling tower, an evaporative cooler, a chiller, or a combination of any of them.

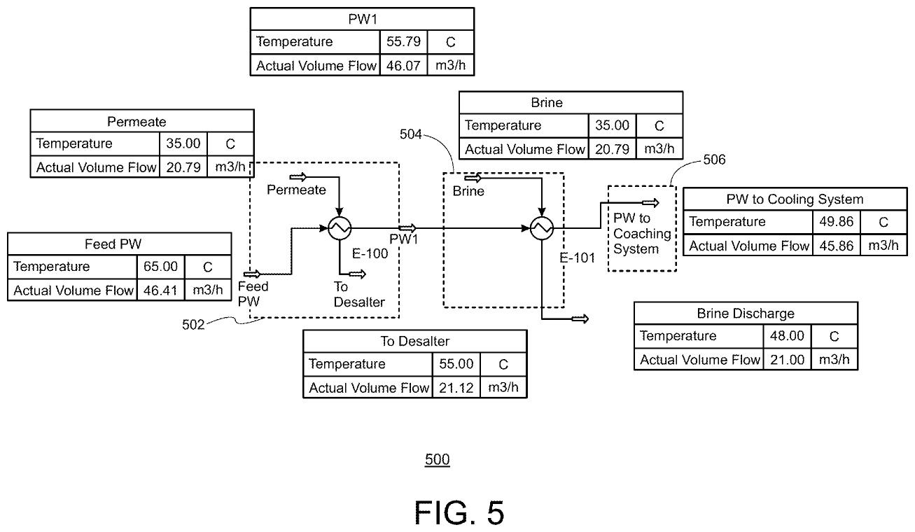

FIG. 5 is a process simulation representing the multi-stage cooling of treated desalter effluent 500 using a combination of heat exchangers and a cooling system. The process simulation describes an example of the heat integration concept with reference to FIG. 4. The initial temperature of the treated produced water (Feed PW) is 65° C. It is processed by the first heat exchanger in block 502. A permeate stream from the desalination unit, at a temperature of 35° C. is used as the cooling medium for the first heat exchanger. The first stage cooled produced water (PW1) exits the first heat exchanger and flows into block 504 for the second stage of cooling. The discharge permeate is heated to 55° C. and recycled to the desalter unit as a wash water stream. A second heat exchanger in block 504 uses the reject brine stream from the desalination unit, which has a temperature of 35° C., as the cooling medium. The exiting second stage cooled produced water enters block 506. Block 506 includes a cooling system that works on the principle of evaporative cooling to produce a third stage cooled produced water. The water entering block 506 has a temperature of −50° C. The third stage cooled produced water is sent to the desalination unit for further continuation of the process. This operates as a continuous cycle, to supply a wash water stream to the desalter unit. The effluent from the desalter is treated and once again filtered, cooled, and desalinated.

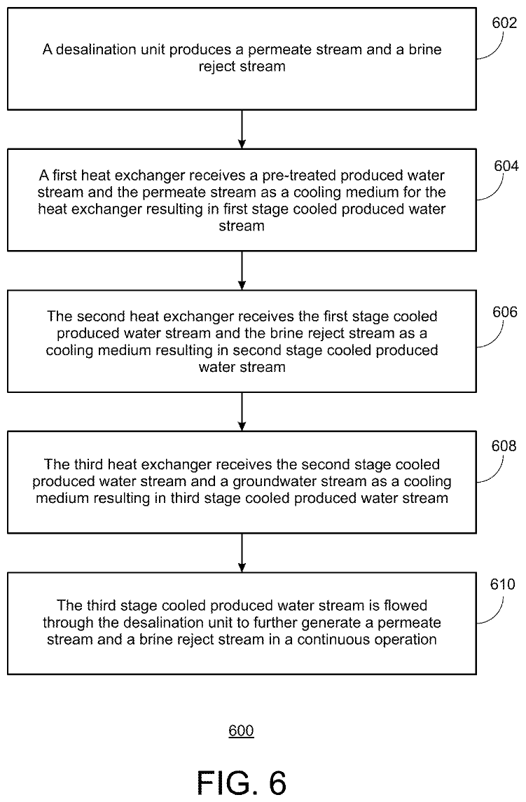

FIG. 6 is a process flow diagram representing the heat integration concept 600. At block 602 the desalination unit produces a permeate stream and a brine reject stream. The desalination unit includes a RO membrane or a NF membrane.

At block 604, the first heat exchanger receives a pre-treated produced water stream from the filtration unit. It also receives the permeate stream from the desalination unit which is used as the cooling medium. As the pre-treated produced water stream is cooled down resulting in a first stage cooled produced water stream, the permeate stream heats up. A portion of the heated permeate stream is used as a wash water stream for the desalter unit.

At block 606, the second heat exchanger receives the first stage cooled produced water stream and the brine reject stream. The brine reject stream is used as a cooling medium for the second heat exchanger. This cooling results in a second stage cooled produced water stream.

At block 608, the third heat exchanger receives the second stage cooled produced water stream. A groundwater stream is used as a cooling medium for the third heat exchanger. This results in a third stage cooled produced water stream. In some GOSPs, there is a non-availability of groundwater. In such cases a cooling tower, evaporative cooler, or chiller can be used for cooling. This cooling system is integrated in series or parallel with the first and second heat exchanger.

At block 610, the third stage cooled produced water stream is processed by the desalination unit. This results in a permeate stream and a brine reject stream. The permeate stream has low salinity, compared to the salinity of the pre-treated produced water stream, and a portion of it is used as a wash water stream or a diluting medium for the wash water stream. The brine reject stream has a high salinity compared to the permeate stream. The permeate and brine reject stream are once again flowed as cooling media for the heat exchanger. This process operates in a continuous cyclic mode.

Table 1 and Table 2 represent a comparison for utilization of cooling tower versus heat exchangers developed for 1000 m³/day capacity of treated desalter water effluent plant. Table 1 compares the carbon footprint of using a cooling tower versus a heat exchanger. As reported in Table 1, the total carbon footprint is 1,200 tons/year for using a cooling tower. The carbon footprint is zero for the use of a heat exchanger, if the cooling medium is integrated in the site, using energy efficient utility services. If the heat integration and efficiency opportunity is present at the site, the use of the heat exchanger will emit 38 tons carbon/year. This is as a result of the power to pump the cooling groundwater back to wells. These results demonstrate the advantages of using a series of heat exchangers over a cooling tower in reducing the carbon footprint of the process.

In Table 2, the represented data compares the performance of both systems and the results show that the annual energy consumption for the cooling tower is around 1,700,000 KWh. Whereas the energy consumption for the heat exchangers is 67,200 KWh, which translates to 4% of the energy consumed by the cooling tower. In addition, the water loss associated with using a cooling tower is around 23,000 m³ per year compared to a negligible water loss from the heat exchanger utilization due to the closed loop nature of the aforementioned configuration.

TABLE 1
Carbon foot print emission of cooling tower vs heat exchanger

| Carbon Foot Print | Cooling | Heat Exchangers | |
|---|---|---|---|
| Emission | Tower | (Groundwater) | Heat Exchangers* |
| Water Lost | 200 | 0 | 0 |
| Equivalent (Ton/year) | | | |
| Electrical Power | 1000 | 38 | 0 |
| Consumption | | | |
| Equivalent (Ton/year) | | | |
| Total Carbon Foot | 1200 | 38 | 0 |
| Print (Ton/year) | | | |

*In case groundwater is not available permeate and brine can be utilized to cool the produced water.

TABLE 2
Performance metrics of cooling tower vs Heat exchanger

| | Cooling | Heat Exchangers | |
|---|---|---|---|
| Performance Metrics | Tower | (Groundwater) | Heat Exchangers* |
| Energy | 1,700,000 | 67,200 | 0 |
| Consumption (KWh) | | | |
| Water Loss (m³/year) | 23,000 | 0 | 0 |

*In case groundwater is not available permeate and brine can be utilized to cool the produced water.

### EXAMPLES

An embodiment described here relates to the method of cooling a produced water stream in a GOSP. The produced water stream is obtained from a high pressure production trap in a GOSP. A desalination unit produces a permeate water stream and a brine reject stream from the produced water stream. The permeate water stream and the produced water stream flow through a first heat exchanger in a plurality of heat exchangers, where the permeate water stream is used as the cooling medium. This results in a first stage cooled produced water stream that has a temperature lower than the temperature of the produced water stream. While the permeate water stream cools the produced water stream, the permeate water stream heats up. The heated permeate water stream is used as a wash water for the desalter unit.

The first stage cooled produced water stream and the brine reject stream flows through the second heat exchanger in a plurality of heat exchangers, where the brine reject stream is used as the cooling medium for the second heat exchanger. This results in a second stage cooled produced water stream. The temperature of the second stage cooled produced water stream is lower than the first stage cooled produced water stream. The second stage cooled produced water stream is further cooled by a cooling system, resulting in a third stage cooled produced water stream that has a temperature lower than the temperature of the second stage cooled produced water stream. The cooling system includes a third heat exchanger that uses groundwater as the cooling medium. In some implementations, the cooling system includes a cooling tower, evaporative cooler, chiller, or a combination of them. The third stage cooled produced water stream flows through the desalination unit which produces a permeate water stream and a brine reject stream. The produced water stream undergoes pre-treatment before flowing through the first heat exchanger. The pre-treatment includes removing suspended oil, emulsified oil, sulfur containing gases, volatile organic compounds (VOCs), hardness, fine colloidal particles, and dissolved organic content. The pre-treated water is cooled down before flowing through the desalination unit. The desalination unit removed total dissolved solids (TDS), also known as ionic content. The desalination unit includes reverse-osmosis membrane, ultra-high pressure reverse osmosis membrane, or nano-filtration membrane.

The produced water stream undergoes pre-treatment before flowing through the first heat exchanger. The pre-treatment includes removing suspended oil, emulsified oil, sulfur containing gases, volatile organic compounds (VOCs), hardness, fine colloidal particles, and dissolved organic content. The pre-treated water is cooled down before flowing through the desalination unit. The desalination unit removed total dissolved solids (TDS), also known as ionic content.

An embodiment described here relates to a system in a GOSP that includes a desalination unit, a first heat exchanger, a second heat exchanger, and a cooling system. The desalination unit is configured to receive the pre-treated produced water stream. The desalination process produces a permeate water stream and a brine reject stream. The first heat exchanger uses the permeate water stream as the cooling medium to reduce the temperature of the pre-treated produced water, resulting in a first stage cooled pre-treated produced water. The permeate water stream's temperature increase during the process. This heated permeate water stream is used as a wash water stream for the desalter unit. The second heat exchanger receives the brine reject stream and the first stage cooled pre-treated produced water and reduces the temperature of the first stage cooled pre-treated produced water to produce a second stage cooled pre-treated produced water.

The cooling system receives the second stage cooled pre-treated produced water to produce a third stage cooled pre-treated produced water that is flowed to the desalination unit. The cooling system includes a third heat exchanger or a cooling tower, evaporative cooler, chiller, or a combination of these. In implementations where a third heat exchanger is used, groundwater is used as the cooling medium. The heat exchangers' efficiency can be improved by the use of extended surface, employing fins, or heat transfer techniques. The pre-treated produced water stream undergoes treatment in a pre-treatment unit which includes a hydroclone, H₂S stripper, coagulation unit, precipitation unit, and filtration system.

An embodiment described here relates to a method of cooling a produced water stream received in a GOSP. The produced water stream is treated to remove suspended oil, emulsions, dissolved gases, and organic contaminants resulting in a pre-treated produced water stream. The pre-treated produced water stream is cooled in a sequence of stages, where the temperature of the pre-treated produced water stream is lowered in each stage of the sequence of stages, resulting in a cooled pre-treated produced water stream. The cooled pre-treated produced water stream is desalinated to produce a permeate stream and a brine reject stream, which are used as the cooling media for one of each sequence of stages to cool the pre-treated produced water stream.

In some implementations, a portion of the cooled pre-treated produced water stream is used as the cooling medium for the first heat exchanger or the second heat exchanger. During the cooling process, the permeate stream is heated up resulting in a heated permeate stream, which is used as a wash water stream for the desalter unit. In implementations here, the method includes cooling the pre-treated produced water stream by a first heat exchanger, a second heat exchanger, a third heat exchanger or a cooling system. In implementations here, desalination of the pre-treated produced water stream includes reverse-osmosis membrane, ultra-high pressure reverse osmosis membrane, or nano-filtration membrane to remove dissolved ionic content.

Other implementations are also within the scope of the following claims.

What is claimed is:

1. A gas oil separation plant (GOSP)-implemented method comprising:
receiving a permeate water stream produced by a desalination unit of a gas oil separation plant (GOSP), wherein the desalination unit further produces a brine reject stream;
flowing the permeate water stream and a produced water stream, wherein the produced water stream is produced by a high pressure production trap of the GOSP, through a first heat exchanger of a plurality of heat exchangers, wherein the permeate water stream is a cooling medium for the first heat exchanger;
cooling, in the first heat exchanger, the produced water stream using the permeate water stream resulting in a first stage cooled produced water stream having a temperature lower than a temperature of the produced water stream flowed through the first heat exchanger;
receiving the brine reject stream produced by the desalination unit;
flowing the brine reject stream and the first stage cooled produced water through a second heat exchanger of a plurality of heat exchangers, wherein the brine reject stream is a cooling medium for the second heat exchanger;
cooling, in the second heat exchanger, the first stage cooled produced water stream using the brine reject stream resulting in a second stage cooled produced water stream having a temperature lower than the temperature of the first stage cooled produced water;
further cooling the second stage cooled produced water stream resulting in a third stage cooled produced water stream having a temperature lower than the temperature of the second stage cooled produced water stream; and
flowing the third stage cooled produced water stream through the desalination unit, wherein the desalination unit uses the third stage cooled produced water to produce the permeate water stream and the brine reject stream.

2. The method of claim 1, wherein cooling the produced water stream using the permeate water stream heats the permeate water stream, wherein the method further comprises flowing a heated permeate water stream as a wash water stream to a desalter unit.

3. The method of claim 1, wherein the method further comprises, before flowing the produced water to the first heat exchanger, pre-treating the produced water stream, wherein pre-treating the produced water comprises:
removing suspended oil from the produced water;
removing emulsified oil from the produced water;
removing sulfur containing gases and volatile organic compounds from the produced water;
removing hardness from the produced water; and
removing fine colloidal particles and dissolved organic content from the produced water before flowing the produced water through the plurality of heat exchangers.

4. The method of claim 1, wherein flowing the third stage cooled produced water stream through the desalination unit removes dissolved ionic content.

5. The method of claim 4, wherein removing the dissolved ionic content from the third stage cooled produced water stream comprises flowing the third stage cooled produced water stream through a reverse-osmosis membrane, ultra-high pressure reverse osmosis membrane, or nano-filtration membrane in the desalination unit.

6. The method of claim 1, further cooling the second stage cooled produced water stream comprises using a cooling system.

7. The method of claim 6, further comprising cooling the second stage cooled produced water by the cooling system comprising a cooling tower, evaporative cooler, chiller, or a third heat exchanger that uses a groundwater stream as the cooling medium.

8. A gas oil separation plant (GOSP) comprising:
a desalination unit configured to receive a pre-treated produced water stream and produces a permeate stream and a brine reject stream;
a first heat exchanger that receives the permeate stream and the pre-treated produced water stream, the first heat exchanger configured to reduce the temperature of the pre-treated produced water stream using the permeate stream as a cooling medium to produce a first stage cooled pre-treated produced water;
a second heat exchanger configured to receive the brine reject stream and the first stage cooled pre-treated produced water, and reduces the temperature of the first stage cooled pre-treated produced water to produce a second stage cooled pre-treated produced water; and
a cooling system configured to receive the second stage cooled pre-treated produced water to produce a third stage cooled pre-treated produced water that is flowed to the desalination unit.

9. The GOSP of claim 8, wherein the pre-treated produced water stream undergoes treatment in a pre-treatment unit which further comprises a hydroclone, H₂S stripper, coagulation unit, precipitation unit, and filtration system.

10. The GOSP of claim 8, wherein the cooling system comprises a heat exchanger that uses a groundwater stream as a cooling medium, a cooling tower, a evaporative cooler, a chiller, or a combination thereof.

11. The GOSP of claim 8, wherein the desalination unit comprises a reverse-osmosis membrane, ultra-high pressure reverse osmosis membrane, or nano-filtration membrane.

12. The GOSP of claim 8, wherein the first heat exchanger and the second heat exchanger's efficiency is enhanced by employing fins, extended surfaces, or heat transfer enhancement techniques.

13. The GOSP of claim 8, wherein the temperature of the permeate stream increases as it reduces the temperature of the pre-treated produced water stream, to produce a heated permeate stream.

14. The GOSP of claim 13, wherein a portion of the heated permeate stream is used as a wash water stream for a desalter unit.

15. A method comprising:
receiving a produced water stream from a gas oil separation plant;
treating the produced water stream to remove suspended oil, emulsions, dissolved gases, and organic contaminants resulting in a pre-treated produced water stream;
cooling the pre-treated produced water stream in a sequence of stages, wherein a temperature of the pre-treated produced water stream is lowered in each stage of the sequence of stages, resulting in a cooled pre-treated produced water stream; and
desalinating the cooled pre-treated produced water stream and producing a permeate stream and a reject brine stream, wherein the permeate stream is used as a cooling medium for one stage of the sequence of stages and the brine reject stream is used as a cooling medium for another stage of the sequence of stages.

16. The method of claim 15, wherein flowing a portion of the cooled pre-treated produced water stream as the cooling medium for the first heat exchanger or the second heat exchanger.

17. The method of claim 15, further comprising heating the permeate stream while cooling the pre-treated produced water stream resulting in a heated permeate stream.

18. The method of claim 17, further comprising flowing the heated permeate stream as a wash water stream to a desalter unit.

19. The method of claim 15, further comprising cooling the pre-treated produced water stream by a first heat exchanger, a second heat exchanger, a third heat exchanger or a cooling system.

20. The method of claim 15, wherein desalinating the cooled pre-treated produced water stream comprises a reverse-osmosis membrane, ultra-high pressure reverse osmosis membrane, or nano-filtration membrane, resulting in the removal of a dissolved ionic content.
